(19) United States
(12) Patent Application Publication
(10) Pub. No.: US 2025/0229401 A1
(43) Pub. Date: Jul. 17, 2025

(54) POWER TOOL

(71) Applicant: Stanley Black & Decker Inc., New Britain, CT (US)

(72) Inventor: Joseph R. Thomson, Durham (GB)

(73) Assignee: Stanley Black & Decker Inc., New Britain, CT (US)

(21) Appl. No.: 19/015,079

(22) Filed: Jan. 9, 2025

Related U.S. Application Data
(60) Provisional application No. 63/621,870, filed on Jan. 17, 2024.

(51) Int. Cl. B25F 5/00

(52) U.S. Cl. CPC B25F 5/001

(57) ABSTRACT

A power tool includes a housing, a motor in the housing, an accessory holder configured to hold a power tool accessory and driven by the motor, a torque tube in the housing, a strain gauge on the torque tube, and a controller. The controller is configured to control operation of the motor based at least in part on a measurement from the strain gauge. The torque tube has a first end and a second end opposite the first end. The second end of the torque tube is rotationally fixed to the housing.

### CROSS REFERENCE TO RELATED APPLICATIONS

This application claims the benefit of and priority to U.S. Provisional Patent Application No. 63/621,870, filed Jan. 17, 2024, which is herein incorporated by reference in its entirety.

### BACKGROUND

The present disclosure relates to power tools, power tools with torque control, and power tools with displays, for example, screwdrivers with torque controls and displays.

### SUMMARY

Aspects of the present disclosure relate to example embodiments of a power tool, for example, a screwdriver.

According to an aspect, an example embodiment of a power tools, includes: a housing; a motor in the housing; an accessory holder configured to hold a power tool accessory and driven by the motor; a torque tube in the housing; a strain gauge on the torque tube; a controller; wherein the controller is configured to control operation of the motor based at least in part on a measurement from the strain gauge. The torque tube may have a first end and a second end opposite the first end. The second end of the torque tube may be rotationally fixed to the housing.

The second end of the torque tube may have splines.

The splines may engage an inner portion of the housing.

The second end of the torque tube may be axially free with respect to the housing.

The power tool may further include a transmission and a gearbox housing at least a portion of the transmission.

The torque tube may surround at least a portion of the gearbox.

A forward end of the gearbox may be fixed to the first end of the torque tube.

The strain gauge may be on a necked down section of the torque tube.

The strain gauge may be disposed at a 45 degree angle with respect to a longitudinal axis of the torque tube.

The accessory holder may be a bit holder.

According to another aspect, and example embodiment of a power tool includes: a housing; a motor in the housing; an accessory holder configured to hold a power tool accessory and driven by the motor; a torque tube in the housing; strain gauges on the torque tube and a controller. The controller may be configured to control operation of the motor based at least in part on measurements from the strain gauges. The torque tube may include a front section, a rear section and a central section between the front section and the rear section. The front section may be configured to engage a bearing.

The rear section may be configured to engage the housing.

The strain gauges may be on the central section.

An outer diameter of the central section may be at least five percent smaller than an outer diameter of the rear section.

The outer diameter of the central section may be at least ten percent smaller than the outer diameter of the rear section.

The outer diameter of the central section may be at least fifteen percent smaller than the outer diameter of the rear section.

According to an aspect of an example embodiment, the power tool may include a transmission and a gearbox housing at least a portion of the transmission. The torque tube may surround at least portion of the gearbox.

A forward end of the gearbox may be fixed to the front section of the torque tube.

The strain gauges may be disposed at a 45-degree angle with respect to a longitudinal axis of the torque tube.

According to an aspect of an example embodiment, a power tool includes: a housing; a motor in the housing; an output shaft selectively driven by the motor; an accessory holder on the output shaft; a torque tube in the housing, the torque tube comprising a front section, a rear section and a central section between the front section and the rear section; strain gauges on the torque tube; a transmission comprising a plurality of gears; a gearbox housing at least a portion of the transmission; and a spindle lock. The torque tube may surround at least a portion of the gearbox. The power tool may be operable in manual operation in which when a user rotates the housing, manual torque is transferred into the torque tube through the rear section, manual torque passes from the rear section to the central section into the gearbox, the torque goes through the gearbox into the spindle lock such that when subjected to the manual torque greater than a motor torque, the spindle lock locks and allows torque to bypass the gearbox and to output into the output shaft.

The power tool may be operable in a motor operation in which the motor is operating to produce the motor torque, wherein in the motor operation, the motor torque is transferred from the motor through the transmission and into the output shaft, a reaction torque is transmitted through the torque tube and the reaction torque is transmitted back into the housing through the torque tube.

The strain gauges may be disposed at a 45-degree angle with respect to a longitudinal axis of the torque tube.

The rear section of the torque tube may have splines. The splines may engage the housing to non-rotatably couple the rear section of the torque tube to the housing.

A forward end of the gearbox may be fixed to the front section of the torque tube.

These and other aspects of various embodiments, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures.

### BRIEF DESCRIPTION OF THE DRAWINGS

Example embodiments of the present application are described with reference to and in conjunction with the accompanying drawings, in which:

FIG. 1 is side view of a screwdriver according to an exemplary embodiment;

FIG. 2 is side view showing internal parts of an exemplary embodiment;

FIG. 3 is a side view of a front portion of an exemplary embodiment;

FIG. 4 is a cross-sectional side view of a front portion of an exemplary embodiment;

FIG. 5 is a perspective view of a torque tube of an exemplary embodiment;

FIG. 6 is a side view of a screwdriver according to an exemplary embodiment;

FIG. 7 is a perspective view of a rear portion of a screwdriver of an exemplary embodiment;

FIG. 8 is a perspective view of a front portion of a screwdriver of an exemplary embodiment;

FIG. 9 is a perspective view of a front portion of a screwdriver of an exemplary embodiment;

FIG. 10 is a cross-sectional view of a screwdriver according to an exemplary embodiment;

FIG. 11 is a cross-sectional view of a portion of a screwdriver according to an exemplary embodiment;

FIG. 12 is an exploded view of selected components of a screwdriver according to an exemplary embodiment;

FIG. 13 is a side view of a partial assembly of components of a screwdriver according to an exemplary embodiment;

FIG. 14 is a cross-sectional side view of a partial assembly of components of a screwdriver according to an exemplary embodiment;

FIG. 15 is a perspective view of a torque tube according to an exemplary embodiment;

FIG. 16 is a side view of a torque tube according to an exemplary embodiment;

FIG. 17 is a cross-sectional side view of a torque tube according to an exemplary embodiment;

FIG. 18 is a rear view of a torque tube according to an exemplary embodiment;

FIG. 19 is a cross-sectional view in a plane perpendicular to a longitudinal axis of a screwdriver according to an exemplary embodiment; and

FIG. 20 is an electrical block diagram according to an exemplary embodiment.

### DETAILED DESCRIPTION OF EXEMPLARY EMBODIMENTS

The drawings are for the purpose of illustration and description only and are not intended as a definition of the limits of the invention. In addition, it should be appreciated that structural features shown or described in any one embodiment herein can be used in other embodiments as well. As used in the specification and in the claims, the singular form of “a”, “an”, and “the” include plural referents unless the context clearly dictates otherwise.

All closed-ended (e.g., between A and B) and open-ended (greater than C) ranges of values disclosed herein explicitly include all ranges that fall within or nest within such ranges. For example, a disclosed range of 1-10 is understood as also disclosing, among other ranged, 2-10, 1-9, 3-9, etc.

As used herein, the terminology “at least one of A, B and C” and “at least one of A, B and C” each mean any one of A, B or C or any combination of A, B and C. For example, at least one of A, B and C may include only A, only B, only C, A and B, A and C, B and C, or A, B and C.

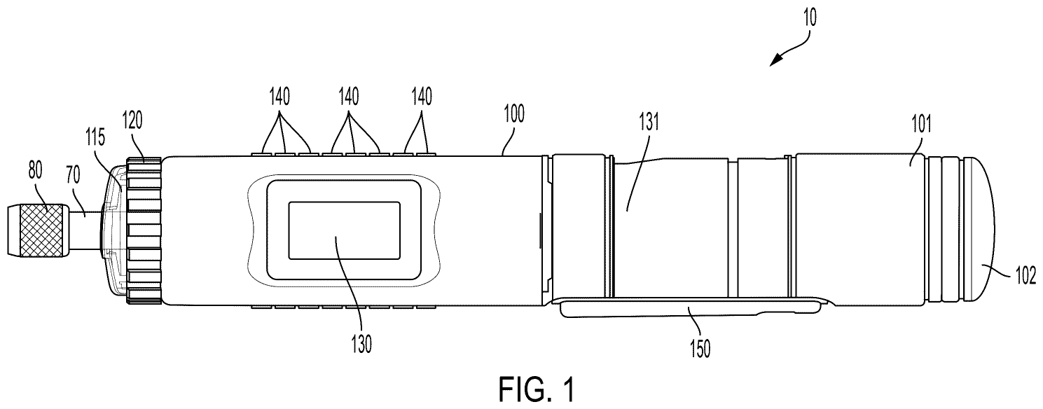

FIG. 1 illustrates an example embodiment of a power tool 10. In the example embodiment, the power tool 10 is a screwdriver 10. As shown, the power tool 10 includes a housing 100. The housing 100 forms a grip portion 101. A trigger 150 is formed at an underside of the grip portion 101. A cap 102 is at a rear of the grip portion 101. The cap 102 may be a removable cap 102. Removing the cap 102 may provide access to a battery for replacement or charging, for example.

The screwdriver 10 may be a powered torque screwdriver 10. The screwdriver 10 may detect an amount of torque, display the detected torque and cut off torque once a set torque is reached.

A display 130 may be at a forward part of the housing 100. The display 130 may be an LCD display and may display various alphanumeric characters and symbols. Additionally, a number of LED lights 140 may be on the housing. The LED lights 140 may be multi-colored LED lights and each light may be able to selectively display different colors. For example, in an example embodiment, each LED light 140 may be capable of displaying the colors green, yellow, red or blue. Accordingly, the LED lights 140 may collectively provide a multi-colored display. For example, at some point, all of the LED lights may display the same color, such as each LED light 140 displaying green. At other times, various LED lights 140 may display different colors, such as one or more LED light 140 displaying green, one or more LED light 140 displaying yellow and one or more LED light 140 displaying red. In other embodiments, the colors of the LEDs may be different.

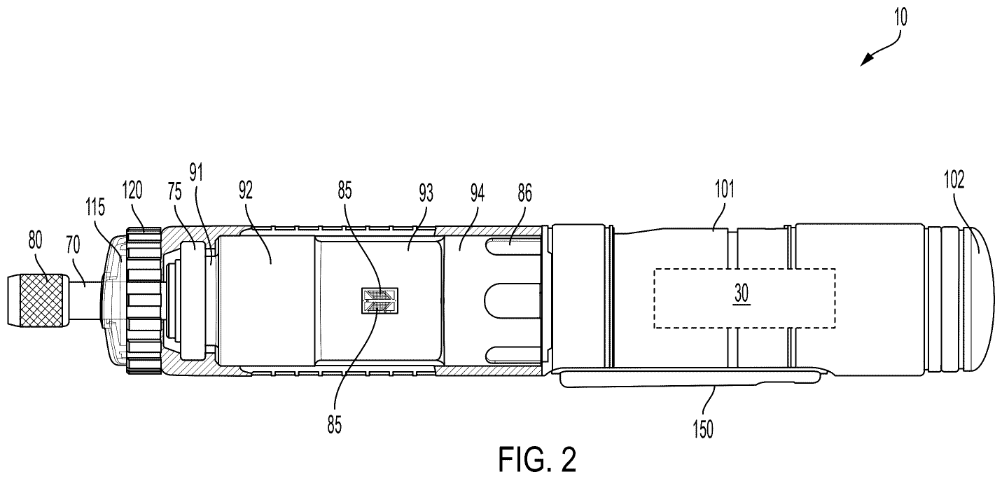

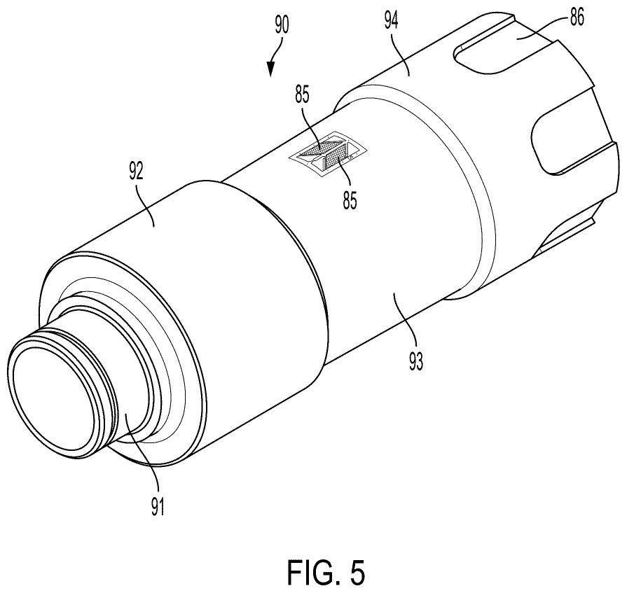

FIGS. 2-5 illustrate various components of the screwdriver 10. As shown in dashed lines in FIG. 2, the screwdriver 10 includes a battery 30. The battery 30 is in a grip portion 101 of the housing. The battery 30 may be a rechargeable battery. In some embodiments, the battery 30 may be removable. The battery 30 provides power to various components of the screwdriver 10, such as motor 50.

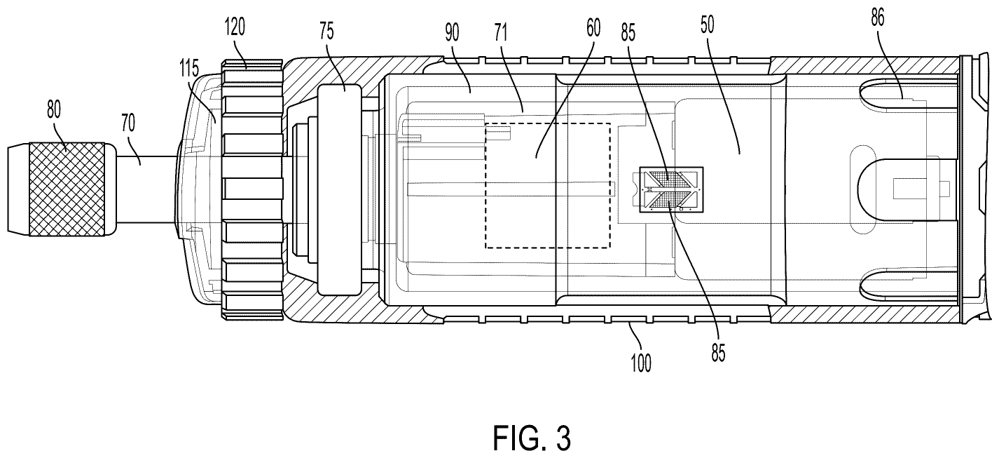

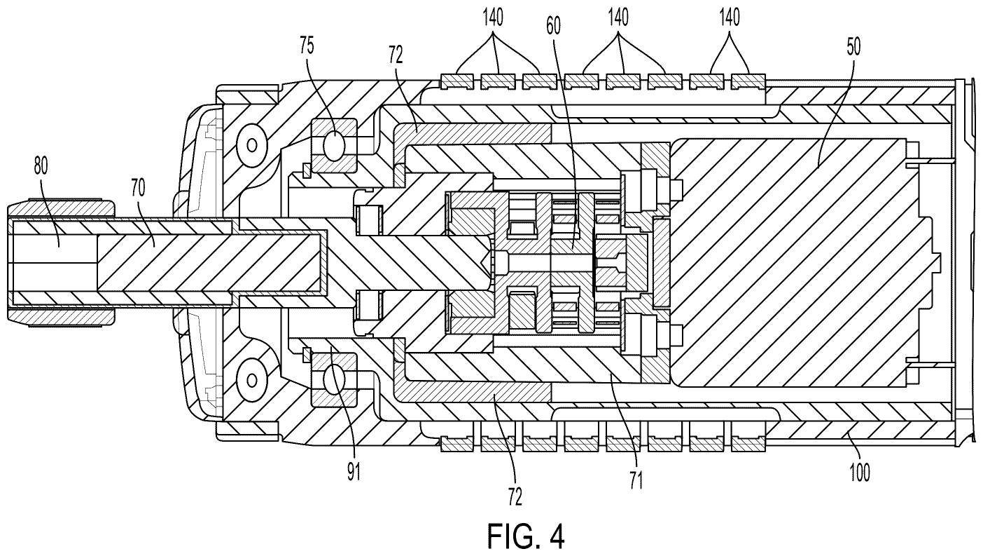

As shown in FIGS. 3 and 4, the screwdriver 10 includes a motor 50. The motor 50 provides rotary power to a transmission 60. The transmission 60 may include one or more planetary gearset. A spindle 70 is driven by the motor 50 through the transmission 60. An accessory holder 80 configured to hold a power tool accessory such as a screwdriver bit. In the example embodiment, the accessory holder is a hex bit holder 80 is on the spindle 70 and is configured to hold a screwdriver bit. In other example embodiments, the accessory holder may be configured to hold a different accessory such as a wrench socket.

As shown in FIGS. 2-4, the screwdriver 10 includes a torque tube 90. The torque tube has a bearing section 91, a front section 92, a central section 93 and a rear section 94. A bearing 75 engages the bearing section 91. A circlip 76 fixes the bearing in place axially. The bearing section 91 of the torque tube 90 may include one or more grooves or ridges to help secure the bearing 75. As shown in FIG. 4, the torque tube 90 may be bonded to the gearcase 71 by a resin 72. As shown, the central section 93 is a necked down section.

In the example embodiments, one or more strain gauges 85 are on the central section 93. The strain gauge or gauges 85 may be disposed at an angle to the rotational axis of the motor 50, spindle 70 and bit holder 80, the rotational axes of the motor 50, spindle 70 and bit holder 80 being concentric. A longitudinal axis of the screwdriver 10 is concentric with the rotational axis of the motor 50, spindle 70 and bit holder 80. The strain gauges 85 may be at an angle of 45 degrees so that the strain gauge or gauges 85 is not influenced by user hand position or pushing and bending loads. In an example embodiment, there may be two strain gauges 85, each at an angle of 45 degrees to the rotational and longitudinal axes and at an angle of 90 degrees to one another. In another example embodiment, there are two sets of such strain gauges, each set on opposite sides of the torque tube 90.

A plurality of spines 86 are on the rear section 94 of the torque tube 90. In the example embodiment, there are six splines 86 evenly spaced about the circumference of the rear section 94 of the torque tube 90. The splines 86 engage an inside of the housing 100. The splines 86 allow for forward and rearward translation, but resist rotation. At the opposite end of the torque tube 90, the bearing 75 engages the bearing section 91 to allow rotation, but prevent translation. Accordingly, a forward end of the torque tube 90 is fixed axially and a rear end of the torque tube 90 is fixed rotationally.

According to the example embodiment, the torque path follows a 45 degree helix and when torque is applied, the strain gauge 85 resistance is proportional to torque and can be used an input into a controller, which may include a microprocessor. The controller can limit a speed of the motor 50 at different user-defined torque set-points. For example, the controller may slow the motor speed at a first set point and effectively cut off the motor at a second set point. In other embodiments, the controller may only have a set point for effectively cutting off the motor 50.

A torque determined by the controller 650 based on input from the strain gauge 85 may be displayed on the display 130 as the torque is measured. For example, the display 130 may display a value of 1.9 Nm when such value is calculate and increase to 2.0 Nm when torque reaches 2.0 Nm. The screwdriver may include a toggle button 131 on the grip portion 101 to change units. For example, instead of Newton-meters (Nm), the display may display torque in foot pounds (ft-lb(s)).

The dial 120 may be used to set a torque limit. The dial 120 may be rotated in one direction to increase the set torque limit and in the opposite direction to decrease the set torque limit.

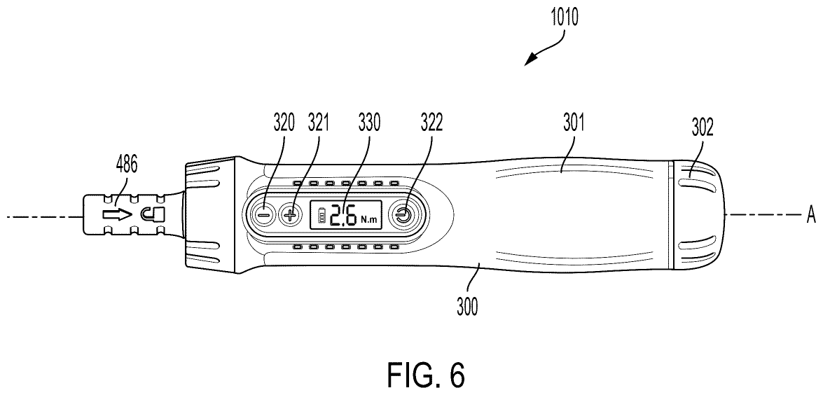

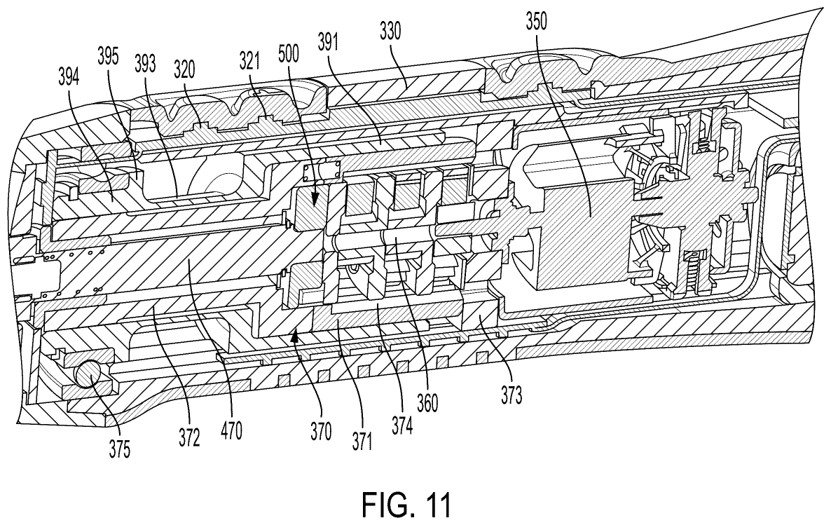

FIGS. 6-18 illustrate another example embodiment of a screwdriver 1010. The exemplary embodiment of a screwdriver 1010 may operate similarly to the screwdriver 10 in at least some aspects. Like the screwdriver 10, the screwdriver 1010 may be a powered torque screwdriver 10. The screwdriver 10 may detect an amount of torque, display the detected torque and cut off torque once a set torque is reached. Features of the screwdrivers 10 and 1010 may be combined and/or substituted for one another unless otherwise specified.

The screwdriver may have a housing 300. A display 330 may be at a forward part of the housing 300. The display 330 may be an LCD display and may display various alphanumeric characters and symbols. Additionally, a number of LED lights 340 may be on the housing. The LED lights 340 may be multi-colored LED lights and each light may be able to selectively display different colors. For example, in an example embodiment, each LED light 340 may be capable of displaying the colors green, yellow, red or blue. Accordingly, the LED lights 340 may collectively provide a multi-colored display. For example, at some point, all of the LED lights may display the same color, such as each LED light 340 displaying green. At other times, various LED lights 340 may display different colors, such as one or more LED light 340 displaying green, one or more LED light 340 displaying yellow and one or more LED light 340 displaying red. In other embodiments, the colors of the LEDs may be different.

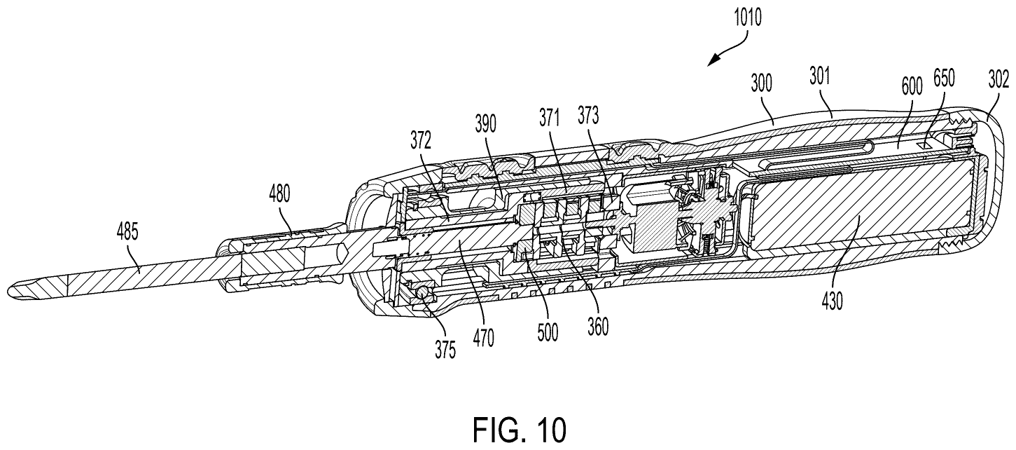

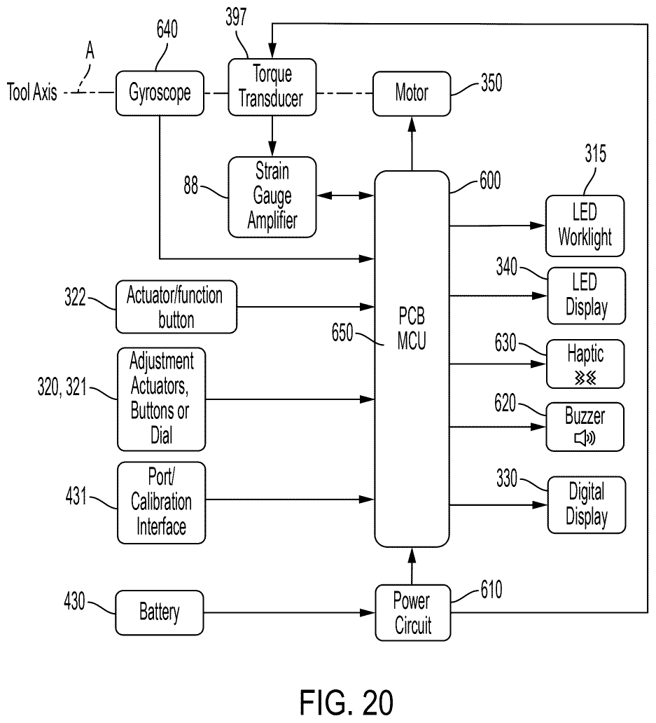

FIG. 10 is a cross-sectional view of the screwdriver 1010. As shown in FIG. 10, the screwdriver 1010 includes a battery 430. The battery 430 is in a rear portion 301 of the housing 300 which may be a grip portion configured for a user to grip. The battery 430 may be a rechargeable battery. In some embodiments, the battery 330 may be removable. The battery 430 provides power to various components of the screwdriver 1010, such as motor 350. A circuit board 600 is adjacent to the battery 330. The circuit board 600 may be a printed circuit board (PCB). Various electronic components, such as a controller 650, may be mounted on the circuit board 600. The circuit board 600 may be electrically connected to the battery 330 and other components by wires and/or other electrical connections. For example, the circuit board 600 may be electrically connected to the strain gauges 85 through wires so that the strain gauges 85 are operatively connected to the controller 650. An electrical block diagram is provided in FIG. 20 and discussed further below.

The motor 350 provides rotary power to a transmission 360. The transmission 360 may include one or more planetary gearset. A spindle 470 is driven by the motor 350 through the transmission 360. A bit holder 480 is on the spindle 470 and is configured to hold a screwdriver bit 485.

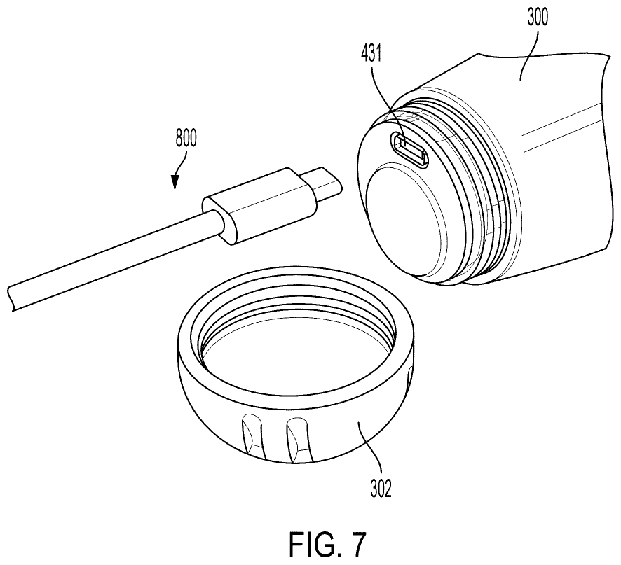

FIG. 7 illustrates a rear end of the screwdriver 1010. As shown, the screwdriver has a removable cap 302. The removable cap 302 of the example embodiment may include a screw thread arrangement for selectively attaching and removing the cap 302. As shown, removing the cap 302 exposes a port 431. The port 431 may be configured to receive a plug for charging the battery 430. In example embodiments, the port 431 may be a USB port of any type and may receive a USB cord/plug 800. In example embodiments, the port 431 may allow for uni-directional charging such that the port is only configured for charging of the battery 430. In other example embodiments, the port 431 may allow for bi-directional charging so that the battery 430 may be charged through the port 431 and the battery 430 may charge other devices through the port 431. The battery 430 may be an integral battery or a removable and replaceable battery. The port 431 may also be used to receive or transmit information. For example, data related to a torque calibration function may be transmitted to a memory or controller 650 through the port 431.

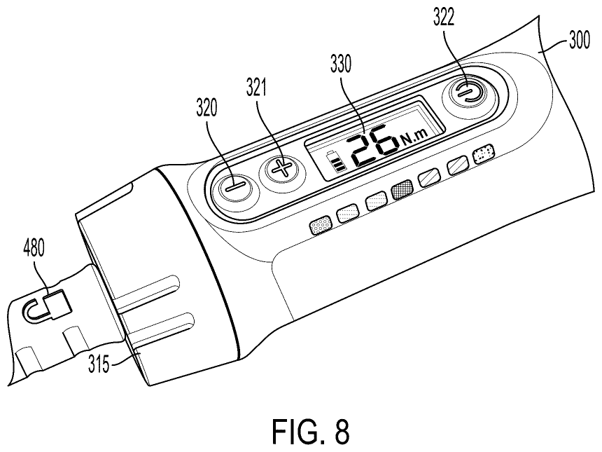

FIG. 8 is a close-up of a portion of the screwdriver 1010. In the example embodiment of the screwdriver 1010, adjustments are made via a plurality of buttons 320, 321, 322. Button 320 may include a subtraction sign “−” indicating a decrease, so that pressing the button 320 may decrease a set torque threshold. Button 321 may include an addition sign “+” indicating an increase in the set torque threshold. Button 322 may be a power or other function button.

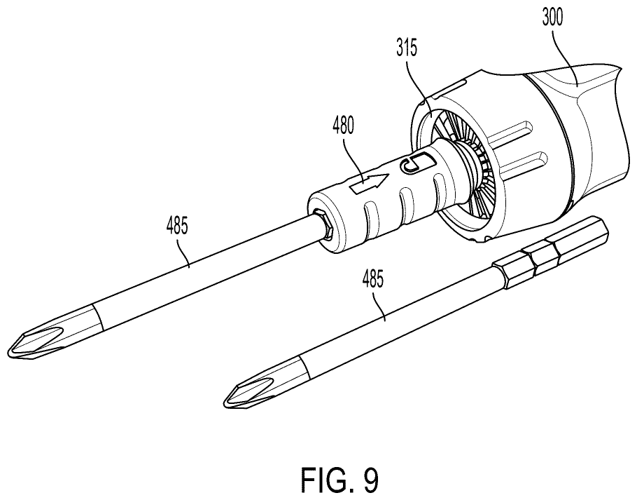

FIG. 9 illustrates a close-up of a forward end of the screwdriver 1010 and a screwdriver bit 385. As shown, a screwdriver bit may be securely held by the bit holder 380. Various screwdriver bits may be held by the bit holder 380 and the screwdriver bits may have different head profiles for driving different fasteners. The screwdriver bits 385 may include 1000V VDE Certified insulated bits. The screwdriver 1010 may include a ring of LED lights 315. The ring of LED lights 315 may include a plurality of LEDs and a lens over the LEDs.

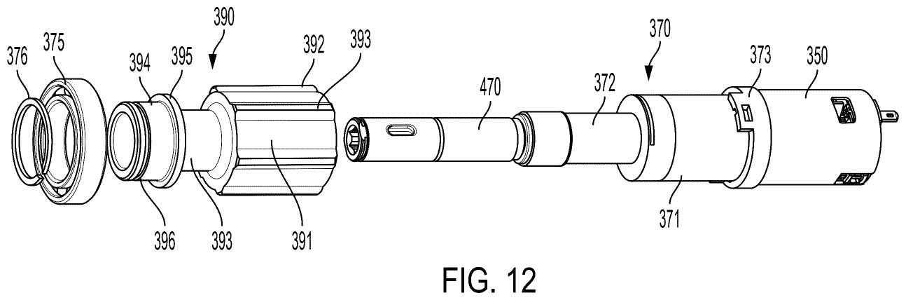

FIG. 12 is an exploded view of various internal components of the screwdriver 1010. In particular, FIG. 12 illustrates the motor 350, gearcase 370 and spindle 470 in an assembled position. FIG. 12 also illustrates a torque tube 390, a bearing 375 and a circlip 376. A motor mount 373 may connect the gearcase 370 to the motor 350. The gearcase 370 may include two components 371 and 372 fixed together such as by a fastener, adhesive, welding or other fixing methods. In other embodiments, the gearcase 370 may consist of a single part. The first gearcase component 371 may directly contact various gears and may include teach 374 for engaging gear teeth. Second gearcase component 372 may serve as a spindle housing 372.

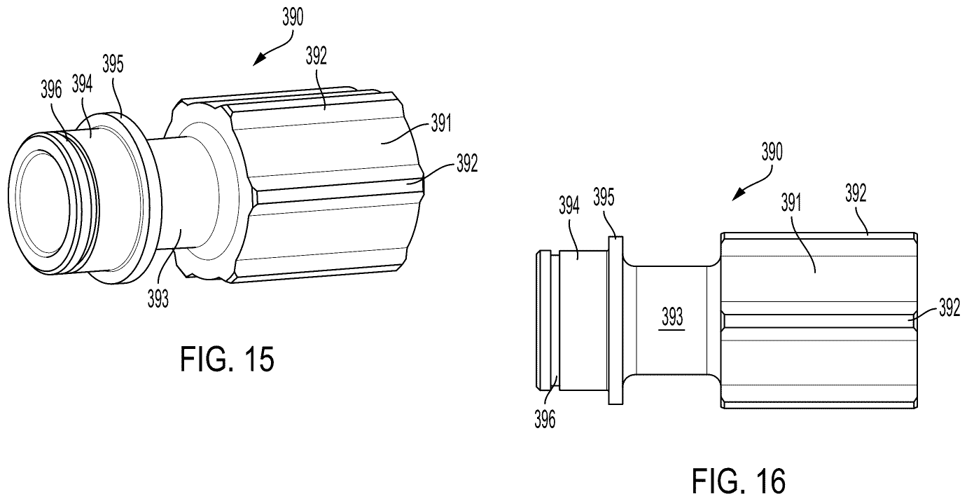

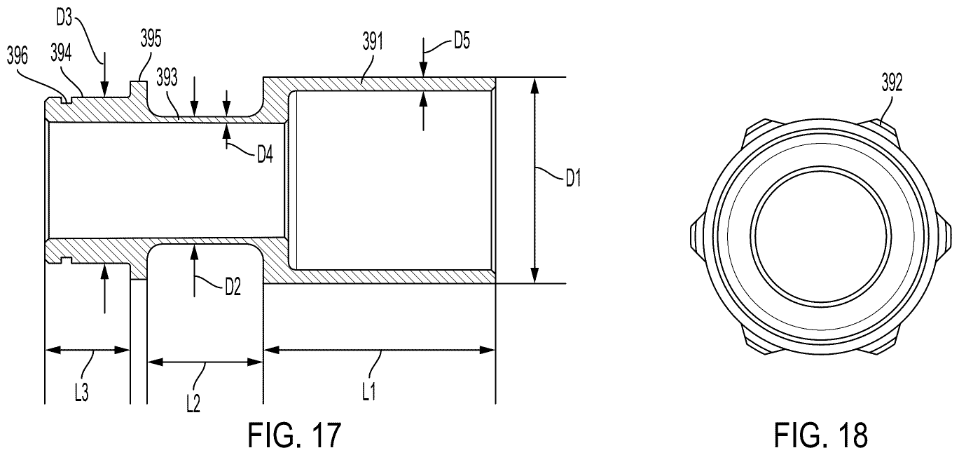

Various view of the torque tube 390 illustrated in FIG. 12 are illustrated in FIGS. 15-18. FIG. 15 is a perspective view of the torque tube 390. FIG. 16 is a side view. FIG. 17 is a cross-sectional side view. FIG. 18 is a rear view.

The torque tube 390 if the example embodiment, includes a first or body section 391. A plurality of projections 392 are disposed on a circumferentially outer surface of the body section 391. The projections 392 extend longitudinally. The projections 392 may be referred to as splines or ribs. In the example embodiment, there are six projections 392. In other example embodiments, there may be at a greater or smaller number of projections. In example embodiments, there may be at least three projections, at least four projections or at least five projections. There may be fewer than twelve projections or fewer than ten projections.

A central section 393 is adjacent to and forward of the body section 391. As shown, the central section 393 is a necked down section and an outer surface of the central section may be substantially smooth. One or more strain gauges 85 are on the central section 393. There may be two, four or eight strain gauges 85 at a 45 degree angle, as previously discussed.

A bearing section 394 is adjacent to and forward of the central section 393. A shoulder 395 separates the bearing section 394 and the central section 393. The bearing section 394 includes a groove 396. The groove 396 is configured to receive a circlip 376. The bearing 375 may be held between the shoulder 395 and the circlip 376.

As shown in FIG. 17, the torque tube 390 may be substantially hollow. The body section 391 may have an outer diameter D1, the central section 393 may have an outer diameter D2 and the bearing section may have an outer diameter D3. The outer diameter D1 is measured from the outer surface of the body portion of the body section 391 and does not include the projections 392. In the example embodiment, D1 is greater than D3 and D3 is greater than D2. As also shown in FIG. 17, the body section 391 has a length L1, the central section 393 has a length L2 and the bearing section or front section 394 has a length. In the example embodiment, L1 is greater than L2 and L2 is greater than L3.

A diameter D2 may be relatively smaller than the diameter D1 and/or the diameter D3. The relatively smaller diameter may help the precision of the measurements of the strain gauge or gauges 85 by helping the strain to be evenly distributed. Having a relatively larger D1 may allow the torque tube 390 to interface with the housing 300 and for the housing to have a size that is more ergonomic for a user. Having a relatively larger D3 may assist with engagement with the bearing.

Diameter D2 may be at least 5% smaller than D1; at least 10% smaller than D1; at least 15% smaller than D1; at least 20% smaller than D1; at least 25% smaller than D1; or at least 30% smaller than D1.

Diameter D2 may be at least 2% smaller than D3; at least 3% smaller than D3; at least 4% smaller than D3; at least 5% smaller than D3; at least 8% smaller than D3; at least 10% smaller than D3; or at least 15% smaller than D3.

In the example embodiment, the central section 393 has a relatively small wall thickness D4. For example, in the example embodiment, the thickness D4 is smaller than the thickness of the body section 391 or the bearing section 394. Having a relatively thin wall section may assist in measuring torque through the strain gauges 85. In example embodiments, the thickness D4 may be less than 8 mm; less than 5 mm; less than 4 mm; less than 3 mm or less than 2 mm.

The body section 395 may have a wall thickness D5 and D4 may be at least 5% smaller than D5; D4 may be at least 10% smaller than D5; at least 15% smaller than D5; at least 20% smaller than D5; or at least 35% smaller than D5.

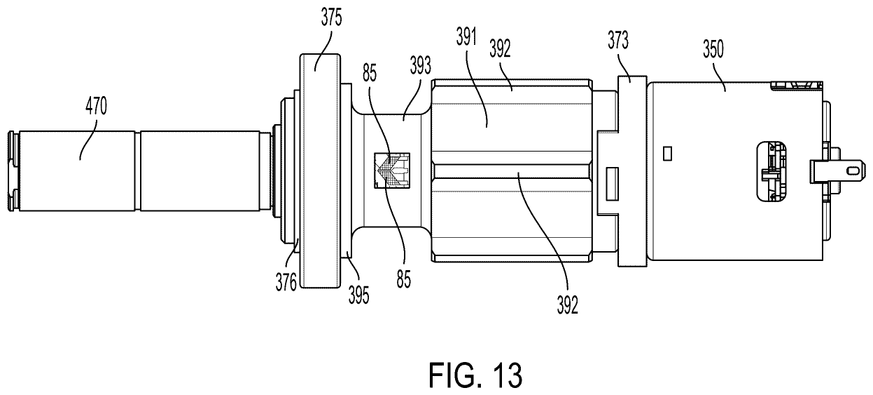

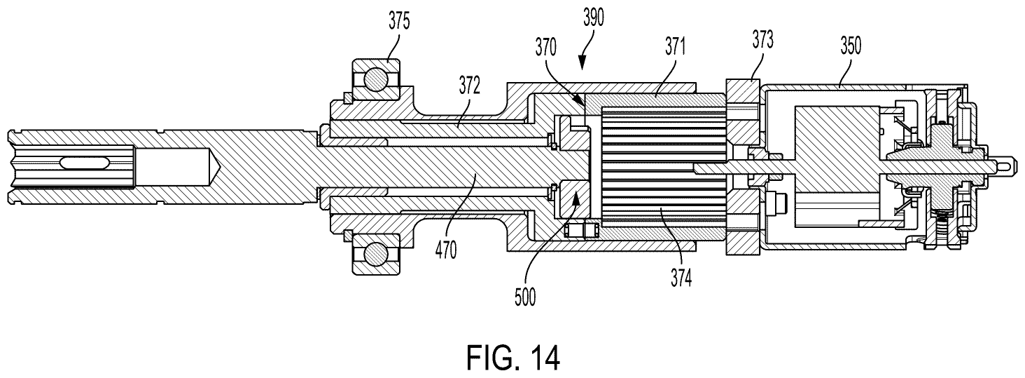

FIG. 13 is an assembled view and FIG. 14 is a cross-sectional view of the assembly. At a rearward position A, the torque tube 390 has a clearance fit and is free to rotate and slide over the gearcase 370 and specifically first gearcase component 371 at that location. At a forward position B, the torque tube 390 is bonded/press fit so that the torque tube 390 is fixed to the gearcase 370, and specifically second gearcase component 372, at this location. At this forward position, the torque tube 390 does not move rotationally or axially with respect to the second gearcase component 372.

The screwdriver includes a spindle lock 500 and may operate in a manual or motor-powered manner of operation. In the manual mode of operation, when the user rotates the housing 300 such as at the grip portion 301, torque is transferred through the housing 300 into the torque tube 390 through the splines 392 which are engaged with the housing as by corresponding splines and/or grooves on an interior of the housing 300. The torque passes from the body section 392 to the central section 393 and into the second component 372 of the gearcase 370, which is press fit or bonded onto the torque tube 390. Torque goes through the gearcase second component 372 to the spindle lock 500. When the manual torque exceeds a motor torque, the spindle lock 500 locks and allows torque to bypass the gearbox 370 and output through the spindle 470 to the bit holder 380 and bit 385.

The screwdriver 1010 may also operate in a motor powered mode of operation in which torque from the motor 350 operates the screwdriver. In the motor-powered mode, the motor 350 is operated and provides torque. The torque is transferred from the motor output shaft, through the gears of the transmission 360 and into the output spindle 470. A reaction torque is transmitted through the gears of the transmission 360 into the gearcase 370. The motor torque is transmitted through the torque tube 390 and into the body section 391. The splines 392 are engaged with the housing 300 and transmit the torque back into the grip portion 301 which is held by a user.

In either manual or motor-powered operation, torque can be measured by the strain gauges 85. The strain gauges 85 in conjunction with the torque tube 390 may together be referred to as a torque transducer.

The screwdriver 1010 also has an axial force path. When a user pushes the screwdriver onto a work piece, force is transmitted from the housing 300 into the bearing 375. The bearing 375 transmits axial force into a fastener, bypassing the torque transducer. The torque transducer does not see any axial force and is thus not influenced by how hard the user is pushing in an axial direction. The body section 391 is free to slide axially while still transmitting torque because it is free to slide and no axial force is trans mitted through the torque transducer.

The screwdriver 1010 may operate with a conventional trigger switch or may include a gyroscopic sensor 640 and operate in accordance with the rotation of the screwdriver such as described in U.S. Patent Application Publication No. 2011/0266014. U.S. Patent Application Publication No. 2011/0266014 is hereby incorporated by reference in its entirety.

In the screwdriver 1010, when the actuator 322 is depressed, the screwdriver 1010 wakes up and the LED light 315 turns on. The LED light 315 may stay on for a period of time, such as at least 10 second, at least 15 seconds or at least 20 seconds. The display screen 460 may also illuminate and show a previously selected torque setting.

The actuator 322 remains depressed by the user. As the actuator 322 is depressed and screwdriver 1010 is rotated, the motor 350 starts. The gyroscopic sensor 640 senses a direction and amount of rotation from an initial starting point. The controller 650 controls the motor 350 to turn in the direction that the screwdriver 1010 is rotated and the speed of the motor 350 is proportional to the amount the screwdriver 1010 is rotated. A larger amount of rotation means a higher rpm for the motor 350. Accordingly, if the user rotates the screwdriver 1010 in a clockwise direction, the bit holder 380 and bit 385 rotates in the clockwise direction. If the user rotates the screwdriver 1010 in a counter-clockwise direction, the bit holder 380 and bit 385 rotates in the counter-clockwise direction.

When the target torque level is approaching, the motor 350 may begin to ramp down in speed. The measured torque is displayed on the display 460. In some example embodiment, the motor 350 may slow down as the measured torque reaches the selected torque setting. In some embodiments, the motor 350 may stop at a threshold before the selected torque setting is reached and allow the user to manually operate the screwdriver to reach the selected torque. The threshold may be within 2% or less of the selected targeted torque setting. The threshold may be within 4% or less of the selected target torque setting. The threshold may be within 6% or less of the selected target torque setting. The threshold may be within 8% or less of the selected target torque setting.

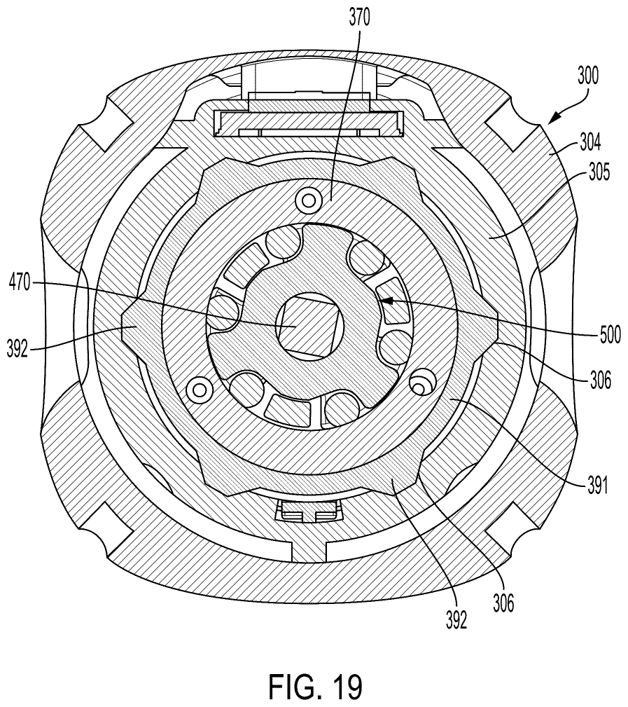

FIG. 19 illustrates a section view of the screwdriver 1010 through the spindle lock 500 in a plane perpendicular to a rotational axis of the motor 350 and longitudinal axis of the torque tube 390. As shown, the spindle 470 is centrally located and engages with the spindle lock 500. The gearcase 370 surrounds the spindle lock 500. The torque tube 900 is outside of the gearcase 370 and includes splines 372. The splines 372 engage with corresponding recesses 306 on an inside of the housing 300. In the example embodiment, the housing includes an outer structure 304 and an inner structure 305 and the recesses 306 are formed on the inner structure 305. The outer structure 304 and the inner structure 305 may include different materials. For example, the outer structure 304 may be made of a plastic and the inner structure 305 may be made of a metal. In the example embodiment, the inner structure 305 may be a metal tube configured to provided stiffness for the power tool 1010.

FIG. 20 illustrates an electrical block diagram for the screwdriver 1010. The screwdriver 10 may operate with the same or a similar electrical configuration. As shown in FIG. 20, the screwdriver 1010 has a tool axis A. The tool axis A is shown in, for example, FIG. 6. The tool axis A is an axis through the motor rotational axis and an axis of the torque tube 390, and so the torque transducer 397 including the torque tube 390 and strain gauges 85. A strain gauge amplifier 88 is operatively connected to the torque transducer 397 and a controller 650.

Various other components are connected to the controller 650 for operation. For example, actuator 322 and adjustment buttons 320, 321 are connected to the controller 650. In the example embodiment of the screwdriver 10, the trigger 150 may serve a similar function as actuator 322 and the dial 120 may serve a similar function as the adjustment buttons 321, 322.

The port 431 may serve as a calibration interface, the LED lights 340 may serve as a bar graph display and the alphanumeric LCD display may serve as a digital display 330. As shown in FIG. 20, the screwdriver 1010 may include a power circuit 610 operatively connected to the battery 430 and the controller 650. The screwdriver 1010 may also include various other types of visual, audio or other feed back. For example, the screwdriver 1010 may include a haptic feedback mechanism 630. The haptic feedback mechanism 630 may include another motor that vibrates the screwdriver 1010. For example, the haptic feedback mechanism 630 may provide haptic feedback when a set torque limit is reached or when there is an error situation. The screwdriver 1010 may also include a buzzer 620. The buzzer 620 may also provide feedback when a set torque limit is reached or there is an error situation.

Example embodiments may improve the controllability of screwdrivers through the use of the torque transducer and mounting arrangement. Example embodiments may permit torque loading through the torque transducer and not any axial or bending forces. Screwdrivers of the example embodiments may be used with relatively small torques. For example, example embodiments may have torque settings of torques in the range of 0.1 to 5 Nm.

The torque tubes of the example embodiments may have splines at one end that restrict rotation but permit sliding. A bearing may be located at the opposite end of the torque tube to allows for rotation, but not bending or axial pushing forces. A gear case may be bonded to the torque tube and the splines may interface with a housing, such that the strain gauges see only torque and not pushing or bending forces. The torque path follows a 45 degree helix and when torque is applied, the strain gauge resistance is proportional to torque so that this measurement can be used by the controller to limit motor speed and/or turn off the motor at various torque set points, such as set points within the range of 0.1 to 5 Nm mentioned above, depending upon the user setting. The screwdriver may be configured so that the motor turns off when a set point is reached or so that the motor is turned off before a set point is reached and the user can then manually rotate the screwdriver to the set point.

The foregoing description of the embodiments has been provided for purposes of illustration and description. It is not intended to be exhaustive or to limit the disclosure. Individual elements or features of a particular embodiment are generally not limited to that particular embodiment, but, where applicable, and can be combined, added to or exchanged with features or elements in other embodiments. The same may also be varied in many ways. Such variations are not to be regarded as a departure from the disclosure, and all such modifications are intended to be included within the scope of the disclosure.

Additionally, while exemplary embodiments are described with respect to a screwdriver, the methods and configurations may also apply to or encompass other power tools such as other tools that hold power tools accessories.

1. A power tool, comprising:
a housing;
a motor in the housing;
an accessory holder configured to hold a power tool accessory and driven by the motor;
a torque tube in the housing;
a strain gauge on the torque tube;
a controller;
wherein the controller is configured to control operation of the motor based at least in part on a measurement from the strain gauge;
wherein the torque tube has a first end and a second end opposite the first end;
wherein the second end of the torque tube is rotationally fixed to the housing.

2. The power tool of claim 1, wherein the second end of the torque tube has splines.

3. The power tool of claim 2, wherein the splines engage an inner portion of the housing.

4. The power tool of claim 1, wherein the second end of the torque tube is axially free with respect to the housing.

5. The power tool of claim 1, further comprising:
a transmission; and
a gearbox housing at least a portion of the transmission;
wherein the torque tube surrounds at least a portion of the gearbox.

6. The power tool of claim 5, wherein a forward end of the gearbox is fixed to the first end of the torque tube.

7. The power tool of claim 1, wherein the strain gauge is on a necked down section of the torque tube.

8. The power tool of claim 1, wherein the strain gauge is disposed at a 45 degree angle with respect to a longitudinal axis of the torque tube.

9. The power tool of claim 1, wherein the accessory holder is a bit holder.

10. A power tool, comprising:
a housing;
a motor in the housing;
an accessory holder configured to hold a power tool accessory and driven by the motor;
a torque tube in the housing;
strain gauges on the torque tube;
a controller;
wherein the controller is configured to control operation of the motor based at least in part on measurements from the strain gauges;
wherein the torque tube comprises a front section, a rear section and a central section between the front section and the rear section;
wherein the front section is configured to engage a bearing;
wherein the rear section is configured to engage the housing;
wherein the strain gauges are on the central section; and
wherein an outer diameter of the central section is at least five percent smaller than an outer diameter of the rear section.

11. The power tool of claim 10, wherein the outer diameter of the central section is at least ten percent smaller than the outer diameter of the rear section.

12. The power tool of claim 10, wherein the outer diameter of the central section is at least fifteen percent smaller than the outer diameter of the rear section.

13. The power tool of claim 10, further comprising:
a transmission; and
a gearbox housing at least a portion of the transmission;
wherein the torque tube surrounds at least a portion of the gearbox.

14. The power tool of claim 10, wherein a forward end of the gearbox is fixed to the front section of the torque tube.

15. The power tool of claim 10, wherein the strain gauges are disposed at a 45-degree angle with respect to a longitudinal axis of the torque tube.

16. A power tool, comprising:
a housing;
a motor in the housing;
an output shaft selectively driven by the motor;
an accessory holder on the output shaft;
a torque tube in the housing, the torque tube comprising a front section, a rear section and a central section between the front section and the rear section;
strain gauges on the torque tube;
a transmission comprising a plurality of gears;
a gearbox housing at least a portion of the transmission; and
a spindle lock;
wherein the torque tube surrounds at least a portion of the gearbox,
wherein the power tool is operable in manual operation in which when a user rotates the housing, manual torque is transferred into the torque tube through the rear section, manual torque passes from the rear section to the central section into the gearbox, the torque goes through the gearbox into the spindle lock such that when subjected to the manual torque greater than a motor torque, the spindle lock locks and allows torque to bypass the gearbox and to output into the output shaft.

17. The power tool of claim 16, wherein the power tool is operable in a motor operation in which the motor is operating to produce the motor torque, wherein in the motor operation, the motor torque is transferred from the motor through the transmission and into the output shaft, a reaction torque is transmitted through the torque tube and the reaction torque is transmitted back into the housing through the torque tube.

18. The power tool of claim 17, wherein the strain gauges are disposed at a 45-degree angle with respect to a longitudinal axis of the torque tube.

19. The power tool of claim 17, wherein the rear section of the torque tube has splines; and
wherein the splines engage the housing to non-rotatably couple the rear section of the torque tube to the housing.

20. The power tool of claim 19, wherein a forward end of the gearbox is fixed to the front section of the torque tube.
